(19) United States
(12) Patent Application Publication
(10) Pub. No.: US 2009/0248590 A2
(43) Pub. Date: Oct. 1, 2009

(54) METHOD AND DEVICE FOR FRANKING MAIL

(75) Inventors: BERND MEYER, KONIGSWINTER (DE); JURGEN LANG, BERGISCH GLADBACH (DE)

Correspondence Address: MARSHALL, GERSTEIN & BORUN LLP, 233 SOUTH WACKER DRIVE, 6300 SEARS TOWER, CHICAGO, IL, 60606-6357, UNITED STATES, 312-474-6300, 312-474-0448, docket@marshallip.com

(73) Assignee: DEUTSCHE POST AG, BONN (DE)

(21) Appl. No.: 11/662,723

(22) Filed: Sep. 12, 2007

(30) Foreign Application Priority Data
Sep. 21, 2004 (DE) 10 2004 046 051.5

(51) Int. Cl. G07B 17/02; G06F 19/00

(52) U.S. Cl. 705/402; 705/404

(57) ABSTRACT

A method for franking mail, whereby a franking mark is generated in a franking unit, transmitted to an operating unit, connected to the franking unit, and printed out in a printing unit. A user interface is provided at the operating unit by the franking unit, and the printing out of the franking mark, generated in the franking unit and transmitted to the operating unit, is controlled by the user interface, whereupon the franking mark is printed exactly once one each piece of mail. The invention further relates to a device suitable for carrying out said method.

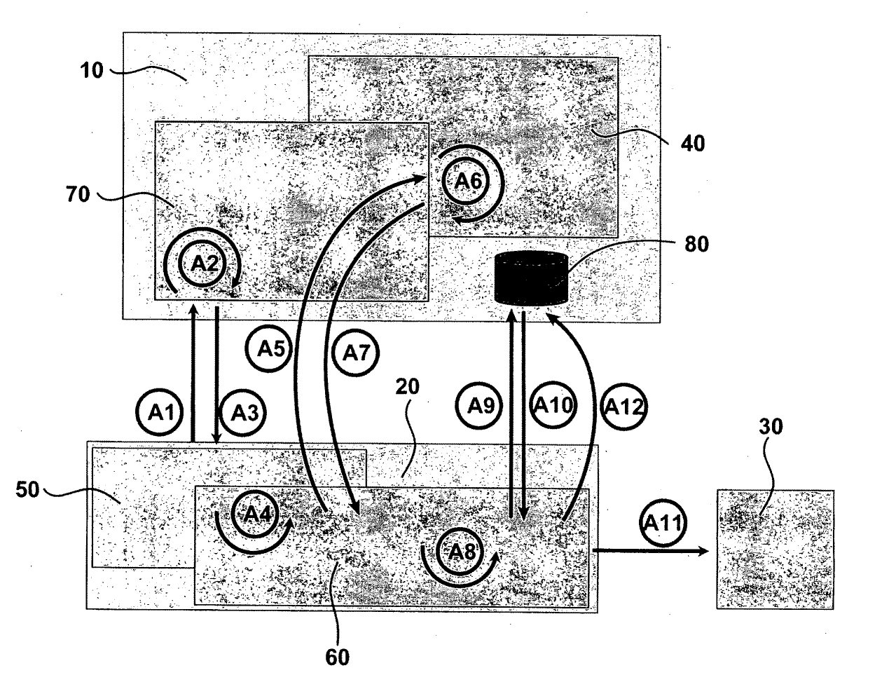

The invention relates to a method for franking mail in which a postage indicium is generated in a franking unit, transmitted to an operating unit and printed out.

The invention also relates to a device for franking mail with a franking unit for generating a postage indicium, with an operating unit connected to the franking unit and with a printing unit for printing out the postage indicium.

Traditional franking systems that use, for example, sender canceling machines for franking mail comprise means for securely generating postage indicia as well as a printing device for printing out the postage indicia.

Modern franking systems are typically divided into central systems and customer systems. Thanks to this division, highly manipulation-proof methods for generating postage indicia that can only be carried out with a great deal of technical effort can be implemented centrally for a large number of customers, while only the printing out of the postage indicia is done at the customers premises.

A method for generating manipulation-proof postage indicia is disclosed, for example, in German patent specification DE 100 20 566 C2 of the applicant. In this known method, postage indicia are generated on the basis of information that identifies the mailpiece and its sender and that is encrypted in a highly secure cryptographic module of a value transfer center in such a manner that it can only be decrypted and verified in a verification center. The sender can then apply the postage indicia onto the mailpieces.

With such a method for generating digital postage indicia, a possibility for manipulation exists is a valid postage indicium is applied multiple times onto mailpieces as a so-called duplicate. On the basis of the information that unambiguously identifies the mailpieces, duplicates can be detected in the verification center, but it is desirable to prevent the printing of duplicates right from the start so that no mailpieces franked with duplicates have to be transported to the verification center.

Consequently, with known methods and devices for franking mail such as, for example, the “STAMPIT” system operated by the applicant, the operating units and/or printing units with which the sender franks the mailpieces are equipped in a special and complicated manner. Special hardware and/or software of the printing units and/or operating units prevent the generation of duplicates.

Hence, it is necessary to equip the operating units and/or printing units with the special equipment and the sender can only use operating units and/or printing units that have been provided with such equipment. This approach entails effort in providing the equipment and moreover, it is associated with restrictions for the sender. Furthermore, the equipment constitutes another potential point of attack for attempts to circumvent the security architecture of the franking system.

Therefore, the invention is based on the object of permitting the simplest and most secure generation of digital postage indicia possible using standard operating units, thus as effectively as possible, preventing duplicates from being printed out.

According to the invention, this object is achieved by a method according to claim 1.

According to the invention, this object is also achieved by a device according to claim 18.

Advantageous refinements of the method and of the device are the subject matter of the subordinate claims.

In particular, the proposal is made that a method for franking mail—in which a postage indicium is generated in a franking unit, transmitted to an operating unit connected to the franking unit and then printed out—is carried out in such a way that a user interface is provided at the operating unit by the franking unit and that the printing of the postage indicium generated in the franking unit and transmitted to the operating unit is controlled by the user interface, whereby the postage indicium is applied onto a mailpiece exactly once.

A method with the above-mentioned features has the advantage that an operating unit run at the user's premises does not have to be equipped in a special manner but rather, a user interface is made available by the central franking unit to a standard operating unit and said user interface especially controls the printing of the postage indicium, in the process preventing the printing of duplicates.

The term user interface is to be understood here in its broadest sense and especially comprises all interfaces that supply control commands with which a communication between the operating unit and the franking unit is controlled and that allow an inventive control of the operating unit and/or of a connected printing unit. The control commands can be made available, for instance, in the form of a computer program that is transmitted by the franking unit to the operating unit.

Preferably, the user interface is implemented in a standard environment that is present in the operating unit, a so-called universal client, in the form of a website and/or of a so-called intelligent document. The universal client is, for example, a web browser or a standard program for interpreting and displaying ordinary and/or intelligent documents, which is referred to here as a reader.

In addition to containing text and graphic elements, intelligent documents also encompass a process logic that is embedded into the document in the form of so-called scripts. Such documents make it possible to change the contents of the document and to carry out predefined processes, either in a context-dependent manner or on the basis of interaction with the user. Moreover, authorizations can be specified, for example, relating to the storage or printing of the intelligent document controlled by the operating unit. In this manner, intelligent documents have properties of the user interface that allow an especially manipulation-proof franking of mailpieces.

In order to carry out the method, the user interface advantageously makes control commands available that especially allow a communication between the operating unit and the franking unit and with which the printing of the postage indicium is controlled. This is preferably done in such a way that the postage indicium is only printed out once.

The security against manipulation is enhanced in a preferred embodiment in that, after the postage indicium has been printed out, information about this printing out is filed in a printing database, whereby the user interface controls the transmission of the information to the printing database. Preferably, the printing database is operated centrally, for example, in the area of the franking unit.

Advantageously, it is provided in this embodiment of the method that, before the postage indicium is printed out by the user interface, a verification procedure checks whether information about the printing of the postage indicium is present in the printing database. Advantageously, the postage indicium is not printed out if the printing database contains information about the printing.

Moreover, the logging of the printing of the postage indicium makes it possible for postage fees for a generated postage indicium to be refunded if no information about the printing of that postage indicium is present in the printing database. Thus, for example, if an error occurred during the printing, a postage refund can be made.

In another advantageous embodiment of the method, it is provided for the request for the postage indicium to be controlled by the user interface.

In order to even more effectively prevent manipulations and especially the printing of duplicates, in this embodiment, it is advantageously provided for the control commands to be changed every time a request for a postage indicium is made. Preferably, information about a request is stored with certain control commands in the area of the franking unit. Moreover, in this embodiment, a repeated request for a postage indicium on the basis of identical control commands is advantageously rejected by the franking unit.

The security of the method can be even further increased in that the printing of a valid postage indicium is controlled in such a way that it only takes place if it has been immediately preceded by a request for a postage indicium. In conjunction with the above-mentioned embodiment of the method, in this embodiment, the generation of a duplicate is prevented especially effectively by linking the request and the printing of the postage indicium.

Advantageously, it is likewise provided that the postage indicium that is to be applied onto the mailpiece is not displayed at the operating unit, so as to prevent a duplicate from being generated on the basis of an image of a postage indicium displayed on a display means.

Preferably, via the user interface, however, a preview of the valid postage indicium is displayed so as to give a user of the operating unit an impression of the valid postage indicium. The preview advantageously contains an invalid postage indicium.

In order to even more effectively prevent manipulations with the method, in another advantageous embodiment of the method, it is provided for data containing the postage indicium to be associated with access rights that do not allow storage in the area of the operating unit.

Advantageously, it is also provided for the control commands for printing out and/or for requesting data containing the postage indicium to be linked to access rights that do not allow storage in the area of the operating unit.

In another preferred embodiment of the method, it is provided for the postage indicium to be incorporated into a document in the area of the franking unit. This can be, for example, a letter, an envelope or an address label.

The document is preferably generated by means of the user interface. In this manner, the method according to the invention is especially user-friendly.

Advantageously, the printing of the document is carried out as explained above in conjunction with the postage indicium.

In addition to the method, the invention also proposes a device for carrying out the method.

The device for franking mail with a franking unit for generating a postage indicium, with an operating unit connected to the franking unit and with a printing unit for printing the postage indicium is especially characterized in that the franking unit comprises a means for providing a user interface to the operating unit with which the printing of a postage indicium can be controlled.

Preferably, the user interface is also configured in such a way that it can be used to control the request for a postage indicium from the franking unit.

In an especially preferred embodiment of the device, the franking unit comprises an existing system for providing the user interface as well as a security module for generating the postage indicium. In this manner, the postage indicium can be generated in a specialized module separately from the other functions of the franking unit, thus ensuring the highest possible security.

The operating unit preferably comprises a standard environment, the so-called universal client, where the user interface is provided.

In an especially preferred embodiment of the device, the franking unit comprises a printing database in which the information about the printing of the postage indicium transmitted by the user interface is stored.

Advantageously, in a preferred embodiment of the device, the user interface has a means for transmitting the information about the printing of the postage indicium as well as a means for querying the printing database.

Advantageously, in another embodiment of the device, the franking unit comprises a database for storing the request for the postage indicium.

It is also advantageous for the franking unit and the operating unit to be connected to each other via a network, preferably via a wide area network (WAN) such as, for instance, the Internet.

In particular, the use of the network makes it advantageously possible for a plurality of operating units to be connected to the franking unit.

Additional advantages, special features and practical refinements of the invention can be gleaned from the subordinate claims and from the presentation below of preferred embodiments making reference to the single FIGURE.

The FIGURE shows a schematic representation of the components for carrying out a method according to the invention and their interrelationship.

Valid postage indicia are generated in a franking nit 10, transmitted to an operating unit 20 and printed out in a printing unit 30 that is connected to the operating unit 20. In this process, the postage indicia is preferably generated fundamentally in the way described in German patent specification DE 100 20 566 C2 of the applicant. Reference is hereby made to this patent in conjunction with the generation of secure postage indicia.

In particular, within the scope of the present invention, it is provided for customers of a service provider of postage indicia to each be assigned a postage account that is administered in the franking unit 10 and into which postage amounts can be loaded for purposes of franking mail. Here, the franking unit 10 is preferably operated as a central unit that administers a plurality of postage accounts and that is connected to a plurality of operating units 20 via a network, for example, via a wide area network (WAN) such as the Internet.

Using cryptographic methods, the franking unit 10, loads the postage amount from a value transfer center of a postal service provider, which is not shown in the FIGURE. In this process, secret information, for example, a random number, is generated in a protected security module within the franking unit 10 and then transmitted to the value transfer center in encrypted form. The security module 40 is configured here as a so-called cryptographic module and is likewise used for generating postage indicia.

In another highly secure cryptographic module of the value transfer center, for each loading procedure, a loading procedure identification number is generated that is unambiguously associated with said loading procedure and that preferably contains especially an identification feature of the user or of the postage account of the user as well as the postage amount. A symmetrical cryptographic method is used in the cryptographic module of the value transfer center to encrypt a combination of the random number and the loading procedure identification number in such a way that it can only be decrypted in a verification center of the postal service provider for purposes of verifying the validity of a postage indicium. The encrypted combination of the random number and the loading procedure identification number forms a so-called crypto-string that is incorporated into the postage indicia.

The loading procedure is completed when the crypto-string and the loading procedure identification number are transmitted in plain text from the value transfer center to the franking unit 10 and when they are received there in the security module 40, after which the loaded postage amount is credited to the postage account. The crypto-string, the loading procedure identification number and the random number are temporarily stored in the security module 40 for purposes of generating postage indicia and are associated with the appropriate postage account.

The postage amount can now be used to generate digital postage indicia that are generated in the security module 40 and applied onto mailpieces by a user employing the operating unit 20 and the printing unit 30.

The operating unit 20 is, for example, a PC with a connected printer that serves as the printing unit 30. The operating unit 20 is connected to the franking unit 10 via a WAN, for example, via the Internet, and it has an input means that can be operated by its user as well as a display means for displaying text and/or graphic elements.

The communication between the operating unit 20 and the franking unit 10 via the WAN is carried out on the basis of protocols that are known to the person skilled in the art. For example, TCP/IP (Transmission Control Protocol/Internet Protocol) and especially HTTP (Hypertext Transfer Protocol) are employed. Moreover, data can be exchanged in encrypted form, for example, on the basis of the SSL (Secure Sockets Layer) protocol.

In the operating unit 20, a standard environment is made available for displaying and executing files, and especially a standard browser 50 for displaying HTML (Hypertext Markup Language) documents and, if applicable, for executing scripts and web-based applications such as, for instance, Java applications. Furthermore, as a standard environment, a reader 60 is provided for displaying and printing text and/or graphic elements contained in files having a specific format such as, for example, PDF (Portable Document Format) or a format used by a standard program for word processing. The reader 60 can be configured in such a way that it can display and interpret ordinary as well as intelligent documents. Here, it can also be provided for the reader 60 to be integrated into the browser 50 as a so-called plug-in.

Hence, any modern PC that has an appropriate reader 60 and a browser 50 can be operated as the operating unit 20 and can be used within the scope of the invention.

In addition to text and/or graphic elements, an intelligent document also contains a process logic that is embedded into the intelligent document in the form of so-called scripts. The process logic of the intelligent document makes it possible to integrate input fields or buttons into the document which, when filled in or actuated, change text and/or graphic elements contained in the document or execute process such as, for example, the printing of the text and/or graphic elements.

Moreover, the content of the intelligent document can be changed in a context-dependent manner, that is to say, as a function of a current value of a certain parameter present in the operating unit 20, and the intelligent document can perform calculations or other processes using the processors and volatile as well as non-volatile memory elements present in the operating unit 20.

Moreover, it is possible for restricted authorizations for storing, printing, copying and/or exporting text and/or graphic elements contained in the intelligent document to be specified on the basis of access rights. This is done independently of the scripts that are embedded into the document in order to relate the access rights to the entire intelligent document, including the control commands contained in the scripts, so that access is denied to the control commands in order to protect the access rights.

In order to ensure the greatest possible compatibility with a large number of differently configured operating units 20, the intelligent documents employed are configured in a platform-independent format and are generated, for example, on the basis of PDF (Portable Document Format) and XML (Extensible Markup Language). Moreover, it is possible to generate the intelligent documents in formats that are used by standard programs for word processing such as, for instance, the “WORD” program made by the Microsoft company.

The franking unit 10 has an existing system 70 for generating websites that can be interpreted and displayed in the browser 50 and for generating ordinary and intelligent documents that can be interpreted and displayed in the reader 60.

In addition to the integration of the existing system 70 and of the security module 40 into the franking unit 10, it can likewise be provided here for the existing system 70 to be an autonomous unit that is connected via suitable connection means, for example, within a network, to the security module 40.

The franking unit 10 also contains a printing database 80 into which information about generated postage indicia and about the printing of these postage indicia is entered. The printing database 80 is connected to the existing system 70 and, if applicable, also to the security module 40.

With the websites and documents that can be displayed in the browser 50 and/or in the reader 60, and especially with the intelligent documents, a user interface is provided via which the user can securely and easily frank mailpieces.

In this process, first of all, one or more websites are transmitted by the existing system 70 to the operating unit 20 and displayed there by means of the browser 50 via which the user indicates mailing-specific data for the mailpiece that is to be franked and selects a document into which the postage indicium is to be incorporated. For the above-mentioned purposes, the websites are configured as forms, for example, as HTML forms.

The mailing-specific data includes particularly information about the mailing class of the mailpiece that is to be franked as well as about the name and address of the recipient of the mailpiece. Examples of documents that are to be incorporated into the postage indicium include, for example, letters, envelopes, address labels or other labels. If applicable, along with the name and address of the recipient, the user also utilizes a website to enter additional text that is to be integrated, for instance, into a letter. Here, it can likewise be provided that the user utilizes the website to indicate a file that contains some or all of the text and graphic elements of the document.

Controlled by the website, the information provided by the user is transmitted to the existing system 70 as is indicated by the reference numeral A1 in the FIGURE, and the information is evaluated there. In particular, text and graphic elements that the user has entered into a website or that were transmitted as a file are converted into a format such as, for example, the XML format, which allows the simplest possible, problem-free generation of a printing master copy for the document. Moreover, the postage amount for the franking of the mailpiece is determined on the basis of the mailing class and the address of the recipient.

On the basis of the evaluated information provided by the user, the existing system 70 generates a preview of the document (A2). In this process, the preview is first imported into a website that is transmitted to the operating unit 20 and displayed to the user by means of the browser 50. The preview contains the text and graphic elements indicated by the user and comprises a sample of the valid postage indicium.

The digital postage indicium contains at least information about the postage amount in plain text, the crypto-string and additional, partially encrypted mailing-specific information. The information here is incorporated into a two-dimensional barcode configured as a matrix code that is applied onto the mailpiece.

In one embodiment of the invention, the sample of the postage indicium contains, for example, crossed-out information about the postage amount and a sample barcode that at least does not contain the crypto-string. The sample is likewise generated in the existing system 70, whereas the security module 40 is provided for the generation of valid postage indicia.

The website with the preview is transmitted to the operating unit 20, as is indicated by the reference numeral A3, and it is displayed by the browser at the operating unit 20, which is indicated in the FIGURE by the reference numeral A4. Via the website showing the preview, the user can then request, for example, by means of an appropriate button contained in the website, a proof or a document with a valid postage indicium.

When a proof is requested, whose transmission to the existing system 70 is controlled by the website, the existing system 70 generates a printing master copy with the preview in the form of an intelligent document. Here, the intelligent document is provided with scripts containing control commands that control the printing of the preview in the printing unit 30 in such a way that this takes place immediately after the intelligent document has been received in the operating unit 20. In this process, the intelligent document is opened by the reader 60 and the control commands contained in the scripts are executed.

The intelligent document with the preview is also configured in such a way that its content is not displayed on a display means of the operating unit 20. For this purpose, for example, the intelligent document can be opened in a so-called hidden frame.

A valid postage indicium is printed out in a similar manner so that, when the proof is printed, the user is familiarized with the procedures for printing the valid postage indicium.

In another embodiment of the invention, however, it can likewise be provided for the printing master copy of the preview to be imported into an ordinary document that, controlled by the reader 60, can be displayed and printed out.

When a document with a valid postage indicium is requested via the website with the preview, first of all, the existing system 70 transmits another website to the operating unit 20 and the user enters identification features and authentication features into said website such as, for example, a user name and an associated password. For this purpose, the website is designed as a form that controls the transmission of the entered features to the existing system 70.

Then, in the area of the franking unit 10, a request for the generation of a valid postage indicium is forwarded via the existing system 70 to the security module 40, indicating the identification features and the authentication features of the user as well as the mailing-specific data that was temporarily stored in the existing system 70. In the FIGURE, the request for the valid postage indicium is shown by the reference numeral A5.

In the security module 40, the identity of the user is verified on the basis of an association between the identification features and the authentication feature that is stored in the database and, after the identity has been verified, the postage account of the user is ascertained. If this account contains a postage credit that is sufficient for the generation of the requested postage indicium, then the valid postage indicium is generated in the security module 40, which is indicated by the reference numeral A6.

In alternative embodiments of the invention, the verification of the identity of the user can also be carried out in one of the preceding steps in the manner described above, for example, before the selection of the mailing class.

In order to generate the postage indicium, a hash value is formed especially on the basis of mailing-specific data such as, for instance, the postage amount, the mailing class, the information about the name and address of the recipient, also on the basis of the current date, of the random number temporarily stored in the security module, of the loading procedure identification number and of a consecutive number. Moreover, the balance in the postage account of the user is reduced by the postage amount used for the franking.

Especially the hash value, the information on the basis of which the hash value is formed, and the crypto-string are incorporated into the postage indicium and imported into the postage indicium.

The postage indicium generated in the security module 20 in this manner is transmitted to the existing system 70, where another intelligent document is generated with the text and graphic elements indicated by the user as well as with the valid postage indicium that is imported into the document as a matrix code. Moreover, an entry about the generation of the intelligent document with the valid postage indicium is entered into the printing database 80, indicating an identification feature of the postage indicium, which is done either by the security module 40 or by the existing system 70.

Scripts are embedded into the intelligent document, said scripts containing control commands that initiate the printing of the document with the valid postage indicium immediately after the intelligent document has been received in the operating unit 20 and after the document has been opened in the reader 60. Moreover, the intelligent document is configured in such a way that it is not displayed by the reader on the display means of the operating unit 20, so as to prevent the printing of a duplicate on the basis of an image on the display.

Moreover, control commands are incorporated into the intelligent document and, after the postage indicium has been printed out, these control commands control the transmission of information containing the identification feature of the postage indicium and about the printing to the printing database 80 (A11) where the information is stored under the appropriate entry for the postage indicium. Before the postage indicium is printed out, control commands contained in the intelligent document control the execution of a query to the printing database 80 (A9, A10) about the presence of information pertaining to the printing. The postage indicium can only be printed out if no such information is present.

Moreover, the intelligent document is provided with access rights that do not permit its content to be printed out through control by the operating unit 20 or by one of its components such as the browser 50 or the reader 60.

Additional access rights can relate to the aspect that the contents are not permitted to be stored in a non-volatile memory of the operating unit 20. Moreover, it can be provided for the valid postage indicium to be deleted from the intelligent document and from the volatile memory of the operating unit 20 by applicable control commands in the intelligent document after the printing has been completed. This is especially advantageous in embodiments of the invention in which no query of the printing database 80 is made before the printing.

The intelligent document configured in this manner with the valid postage indicium is transmitted by the existing system 70 to the operating unit 20, as is shown in the FIGURE by the reference numeral A7. In the area of the operating unit 20, the intelligent document is stored in a volatile memory and the reader 60 interprets the content of the document and especially the control commands embedded in the intelligent document. The printing of the document with the postage indicium is initiated according to the control commands immediately after the intelligent document has been received in the operating unit (A8). The contents of the document are not displayed on the display means of the operating unit 20; the document is opened by the reader 60, for example, in a hidden frame.

In accordance with the control commands, first of all, a query about the presence of information about a printing of the postage indicium that has already occurred is transmitted by the operating unit 20 to the franking unit 10, as is shown by the reference numeral A9. On the basis of the identification feature of the postage indicium that was transmitted together with the query, a checking procedure is carried out in the printing database 80, in the area of the franking unit 10, for example, by the existing system 70, to ascertain whether information about the printing of the postage indicium is present. If this is the case, a notification to this effect is transmitted to the operating unit 20 and the printing of the document with the postage indicium is not carried out by the intelligent document.

If no information about the printing is present, the document with the valid postage indicium is printed out in the printing unit 30 after a notification of receipt of a notification to this effect has been transmitted to the operating unit 20. The transmission of the notification is illustrated by the reference numeral A10. The printing in the printing unit 30 is carried out according to the control commands in the intelligent document and is indicated in the FIGURE by the reference numeral A11.

After the printing has taken place, once again controlled by the applicable control commands in the intelligent document, information about the completed printing, together with the identification feature of the postage indicium, is transmitted by the operating unit 20 to the franking unit 10, as is indicated by the reference numeral A12, and this information is stored in the printing database 80 under the appropriate entry for that postage indicium. Once again, this can be carried out, for instance, by the existing system 70.

Owing to the database query before the postage indicium is printed, the printing of duplicates can thus be effectively prevented. Moreover, the logging of the printing in the printing database 80 makes it possible for the user to prove, if necessary, that the printout was not generated, for example, because of an error. Here, it is provided for the postage amount to be refunded if a generated postage indicium was not printed out.

Another embodiment of the invention provides for the request for a document with a valid postage indicium not to be carried out via a website but rather likewise via an intelligent document. This can be, for example, an intelligent document which contains the preview of the valid postage indicium and into which the valid postage indicium is incorporated.

This intelligent document contains control commands with which the request for a valid postage indicium can be controlled. Moreover, said intelligent document can be provided with access rights that prohibit storage in the area of the operating unit 20 in order to prevent the intelligent document from being instructed at a later point in time to request a postage indicium once again, thus generating a duplicate.

The document with the preview thus configured is transmitted by the existing system 70 to the operating unit 20 (A3). In the area of the operating unit 20, the reader 60 interprets the content of the document and in this embodiment displays the contained preview on a display means of the operating unit 20. The intelligent document is stored in a volatile memory of the operating unit 20.

The preview can be printed out by the printing unit 30, whereby the printing is controlled either by the reader 60 or by the intelligent document. In the latter case, the intelligent document can be provided with access rights that prohibit the printing of contents and this is controlled by the operating unit 20 or by components contained in the operating unit 20. In order to initiate the printing, the intelligent document contains, for example, a button whose actuation triggers the printing procedure.

In addition to the preview, the intelligent document contains a means for requesting the document with the valid postage indicium from the franking unit 10. This is likewise, for example, an appropriate button whose actuation initiates the request and that preferably disappears after being actuated once so as to prevent another request for that postage indicium in order to generate a duplicate.

During this procedure, a request for the transmission and printing of the document with a valid postage indicium, controlled by scripts contained in the intelligent document, is transmitted to the franking unit 10 (A5) where it is forwarded to the security module 40, indicating the identification features and the authentication features of the user.

Here, every intelligent document that controls the request for a valid postage indicium is provided with individual control commands that are unambiguously associated with that intelligent document. This is done, for instance, in that a feature such as, for example, an identification number that is unambiguously associated with the intelligent document, is incorporated into said intelligent document.

The features that are unambiguously associated with the document are likewise transmitted to the franking unit 10 and, in the area of the existing system 70 or of the security module 40, a verification is carried out in a database to check whether a postage indicium based on that particular feature had already been requested. If this is the case, then the request is denied. In this manner, it is prevented that a duplicate can be requested on the basis of a stored document.

The valid postage indicium is generated (A6) in the security module 40 in the above-mentioned manner, transmitted (A7) via the existing system 70 to the operating unit 20, where it is incorporated into the existing intelligent document. Said document is configured in such a manner that control commands control the printing so that, rather than the sample, it is the document that was displayed as the preview that is sent to the printing unit 30 with the valid postage indicium and then printed out. The valid postage indicium is not displayed on a display means of the operating unit, thereby preventing a duplicate from being generated on the basis of the displayed image.

The printing is performed in the above-mentioned manner on the basis of a request to the printing database 80 controlled by means of the scripts in the intelligent document. Moreover, after the printing, information about this printing is once again stored in the printing database 80.

However, in this embodiment, a repeated printing of the document is additionally prevented in that the printing of the digital document with a valid postage indicium and the request logged in the area of the franking unit are linked to each other and cannot be carried out separately from each other. It is not possible to print the document with a valid postage indicium from a stored intelligent document, circumventing the scripts for controlling the printing that are contained in the intelligent document, since these scripts are needed in order to incorporate the valid postage indicium into the document that at first contains the sample.

Especially in the above-described embodiment of the invention in which the request for the valid postage indicium is also controlled by an intelligent document, it can also be provided to dispense with the printing database 80 and with queries about a printing of the postage indicium that has already occurred.

Particularly in this embodiment but also in the previously described embodiments of the invention, the security against manipulation can be increased in that, by appropriately defining access rights, the storage of an intelligent document containing a valid postage indicium and/or control commands for requesting a valid postage indicium in a non-volatile memory of the operating unit 20 is not permitted.

Moreover, after being printed out, the postage indicium contained in the document can be deleted from the document or canceled by appropriate control commands embedded in the intelligent document, and scripts such as, for example, the script containing the control commands for requesting the valid postage indicium, can be at least partially deleted after they have been executed once. Consequently, if someone manages to store the intelligent document, then another printout of the content of the intelligent document does not contain a valid postage indicium and scripts cannot be executed a second time, so that, in these embodiments of the invention, the printing of duplicates is likewise effectively prevented.

Additional embodiments of the invention contain modifications relating to the point in time of the generation of the valid postage indicium and to its provision.

In the above-described sequences, the valid postage indicium is only generated once the preview has been transmitted to the operating unit 10 and subsequently the valid postage indicium has been requested (A5).

However, by the same token, it is possible to generate the valid postage indicium already after the evaluation by the existing system 70 of the information about the mailing class and about the recipient that was entered by the user in Step A1.

Here, the postage indicium is generated in the already described manner (A6), but first temporarily stored in the existing system 70. After the request for the valid postage indicium, the postage indicium is then transmitted (A7) to the operating unit 20 in the manner described above and printed out (A9 to A12).

It is likewise possible to generate the valid postage indicium before the preview with the sample has been generated (A2) and to embed it into an intelligent document together with the sample. In this case as well, the intelligent document is configured in such a way that the valid postage indicium is not displayed at the operating unit 20 and that the printing of the document with the valid postage indicium can only take place in a manner controlled by the scripts of the intelligent document. This is done in one of the ways described above.

The invention offers an advantageous possibility for secure and simple franking of mailpieces in which especially the printing of duplicates is prevented. The various embodiments of the invention presented here are not to be construed as being exclusive but rather, the features of various embodiments of the invention can be combined with each other.

The mailpieces franked by means of the method of the invention are taken to the postal service provider in the conventional manner. The franking is verified in the verification center.

### LIST OF REFERENCE NUMERALS

10 franking unit
20 operating unit
30 printing unit
40 security module
50 browser
60 reader
70 existing system
80 printing database
A1 transmission of information about the mailing class, about a name and address of a recipient and about a document into which the postage indicium is to be incorporated
A2 generation of a preview of the postage indicium
A3 transmission of the preview
A4 display and/or printing of the preview
A5 request for a valid postage indicium
A6 generation of the valid postage indicium
A7 transmission of the valid postage indicium
A8 initiation of the printing of the postage indicium
A9 transmission of a query about the presence of information pertaining to the printing of that postage indicium
A10 transmission of a notification about the presence of information pertaining to the printing of that postage indicium
A11 actuation of the printing unit for printing the postage indicium
A12 transmission of information about the printing of the postage indicium

1. A method for franking mail in which a postage indicium is generated in a franking unit, transmitted to an operating unit connected to the franking unit and printed out in a printing unit,
characterized in that
a user interface is provided at the operating unit (20) by the franking unit (10) and in that the printing of the postage indicium generated in the franking unit and transmitted to the operating unit (20) is controlled by the user interface, whereby the postage indicium is applied onto a mailpiece exactly once.

2. The method according to claim 1,
characterized in that
the user interface makes control commands available with which a communication between the operating unit (20) and the franking unit (10) as well as the printing of the postage indicium are controlled.

3. The method according to either claim 1 or claim 2,
characterized in that
after a postage indicium has been printed out, information about this printing out is filed in a printing database (80), whereby the information is transmitted to the printing database (80) by the user interface.

4. The method according to any of the preceding claims,
characterized in that
before the postage indicium is printed out by the user interface, a verification procedure checks whether information about the printing of the postage indicium is present in the printing database (80).

5. The method according to any of the preceding claims,
characterized in that
the postage indicium is not printed out if the printing database (80) contains information about the printing.

6. The method according to any of the preceding claims,
characterized in that
postage fees for a generated postage indicium are refunded if no information about the printing of that postage indicium is present in the printing database (80).

7. The method according to any of the preceding claims,
characterized in that
the request for the postage indicium is controlled by the user interface.

8. The method according to any of the preceding claims,
characterized in that
the control commands are changed by the franking unit (10) every time a request for a postage indicium is made.

9. The method according to any of the preceding claims,
characterized in that
information about a request is stored with a certain control command in the area of the franking unit (10).

10. The method according to any of the preceding claims,
characterized in that
a repeated request for a postage indicium on the basis of identical control commands is rejected by the franking unit (10).

11. The method according to any of the preceding claims,
characterized in that
the printing of the postage indicium only takes place if it has been immediately preceded by the request for that postage indicium.

12. The method according to any of the preceding claims,
characterized in that
via the user interface, a preview of a valid postage indicium is displayed which contains an invalid postage indicium.

13. The method according to any of the preceding claims,
characterized in that
the valid postage indicium is not displayed at the operating unit (20).

14. The method according to any of the preceding claims,
characterized in that
data containing the postage indicium is associated with access rights that do not allow storage in the area of the operating unit (20).

15. The method according to any of the preceding claims,
characterized in that
data containing the control commands is associated with access rights that do not allow storage in the area of the operating unit (20).

16. The method according to any of the preceding claims,
characterized in that
the postage indicium is incorporated into a document in the area of the fraitking unit (10).

17. The method according to any of the preceding claims,
characterized in that
the document is generated by means of the user interface.

18. A device for franking mail with a franking unit for generating a postage indicium and with an operating unit connected to the franking unit and with a printing unit for printing out the postage indicium,
characterized in that
the franking unit (10) comprises a means (70) for providing a user interface to the operating unit (20) with which the printing of the postage indicium can be controlled.

19. The device according to claim 18,
characterized in that
the request for a postage indicium from the franking unit (10) can be controlled with the user interface.

20. The device according to either claim 18 or claim 19,
characterized in that
the franking unit (10) comprises an existing system (70) for providing the user interface as well as a security module (40) for generating the postage indicium.

21. The device according to any of claims 18 to 20,
characterized in that
the operating unit (20) comprises a standard environment (50, 60) where the user interface is provided.

22. The device according to any of claims 18 to 21,
characterized in that
the franking unit (10) comprises a printing database (80) in which the information about the printing of the postage indicium transmitted by the user interface is stored.

23. The device according to any of claims 18 to 22,
characterized in that
the user interface has a means for transmitting the information about the printing of the postage indicium as well as a means for querying the printing database (80).

24. The device according to any of claims 18 to 23,
characterized in that
the franking unit (10) comprises a database for storing the request for a postage indicium.

25. The device according to any of claims 18 to 24,
characterized in that
the franking unit (10) and the operating unit (20) are connected to each other via a network.

26. The device according to any of claims 18 to 25,
characterized in that
a plurality of operating units (20) are connected to the franking unit (10).
